(19) United States
(12) Patent Application Publication
(10) Pub. No.: US 2012/0173447 A1
(43) Pub. Date: Jul. 5, 2012

(54) METHOD AND DEVICE FOR CONTENT TRACKING

(75) Inventors: Stefan Ljungkrantz, Campinas (BR); Rosilaine S.R. Ljungkrantz, Campinas (BR); Igor Smagasz Barros, Santana (BR); Gustavo Pavao Da Silveira, Campinas (BR); Claudemir Borba, Indaiatuba (BR); Daniela Rodrigues Alves, Sao Paulo (BR); Daniela Grassitelli Fernandes, Campina (BR); Gian Paolo Garuti, Modena (IT); Gianni Corazzari, San Felipe Sul Panaro (IT)

(73) Assignee: TETRA LAVAL HOLDINGS & FINANCE S.A., Pully (CH)

(21) Appl. No.: 13/386,529

(22) PCT Filed: May 26, 2010
(86) PCT No.: PCT/SE2010/000144

§ 371 Date: Mar. 21, 2012

(30) Foreign Application Priority Data
Jul. 24, 2009 (SE) 0901035-6

(51) Int. Cl. G06Q 10/08

(52) U.S. Cl. 705/333

(57) ABSTRACT

A method for content tracking of a packaged content comprises: obtaining information of the raw material; obtaining transport information; obtaining process information; obtaining packaging information; storing the information of raw material, transport information, process information and packaging information in a database; cross referring the stored information; generating an output comprising the cross referenced information; and labeling the package with the output. Furthermore, a device for content tracking of a packaged content is disclosed. Use of the method and the device, for content tracking of a packaged content, is also disclosed.

### TECHNICAL FIELD

The present invention relates in general to the field of content tracking. More particularly the invention relates to a method for tracking the content of a package.

### BACKGROUND

In the global market of today, goods move freely in a way never seen before. Different parts of the production and supply chains, such as raw materials, production facilities, distribution lines and end consumers, may have very different geographical locations. This makes it hard to overview transfer of goods, with possible economical, environmental or health disadvantages. Furthermore, the distribution speed is high, which increases the risk of spreading erroneous products. In order to avoid unnecessary risks and costs, there is thus a need for better information management, to increase the possibilities of tracing different products.

Several sets of regulations, such as the Hazard Analysis and Critical Control Point (IIACCP) program or the ISO 9000 certification underline the need for traceability of various products, such as food products.

Thus, there is a need to increase possibilities for, and accuracy of content tracking.

### SUMMARY

The present invention is based on the understanding that a specific method of obtaining and cross referring information enables content tracking.

According to a first aspect, there is provided a method for content tracking of a packaged content. The method comprises the steps of obtaining information of the raw material; obtaining transport information; obtaining process information; obtaining packaging information; storing said information of raw material, transport information, process information and packaging information in a database; cross referring said stored information; generating an output comprising said cross referenced information; and labeling the package with said output.

The method may further comprise the steps of obtaining secondary packaging information storing said secondary packaging information in a database; cross referring said stored information; generating a second output comprising said cross referenced information; and labeling the secondary package with said second output.

At least one of the steps of the method may be automatic.

At least one of the steps of the method may be manual.

The information may be stored together with a time stamp.

The cross referring may be performed by synchronizing time stamps of the stored information.

The information may be stored in a database with a certificate to assure that the data remains intact.

According to a second aspect, there is provided a device for content tracking of a packaged content. Said device comprises a first unit configured to obtain information of the raw material; a second unit configured to obtain transport information; a third unit configured to obtain process information; a fourth unit configured to obtain packaging information; a fifth unit configured to store said information of raw material, transport information, process information and packaging information in a database; a sixth unit configured to cross refer said stored information; a seventh unit configured to generate an output comprising said cross referenced information; and an eight unit configured to label the package with said output. Said units are operatively connected to each other.

The device may further comprise a ninth unit configured to obtain secondary packaging information; a tenth unit configured to store said secondary packaging information in a database; an eleventh unit configured to cross refer said stored information; a twelfth unit configured to generate a second output comprising said cross referenced information; and a thirteenth unit configured to label the secondary package with said second output.

According to a third aspect, there is provided a use of the method according to the first aspect or the device according to the second aspect, for content tracking of a packaged content.

According to a fourth aspect, there is provided a computer program including program instructions which when executed by a processor cause the processor to perform the method according to the first aspect.

The instructions may cause the processor to, based on a labeling information from a package, retrieve the stored information.

The instructions may cause the processor to, based on any of the stored information of raw material, transport information, process information and packaging information in the database, determine any labels of packages associated therewith.

The instructions for retrieving the stored information and for determining labels of packages, respectively, may be arranged to form separate computer programs.

Advantages with the present invention is that it enables automated quality control, enables surgical recall which reduces waste, enables full traceability of origin, destination, process and quality, increases transparency, customer safety and satisfaction.

### BRIEF DESCRIPTION OF DRAWINGS

These and other aspects, features and advantages of the invention will be apparent and from the following description of embodiments of the present invention, wherein reference is made to the accompanying drawings, in which

FIG. 1 is a schematic flowchart of a method according to an embodiment;

FIG. 2 is a schematic flowchart of a method according to another embodiment;

FIG. 3 is a schematic overview of dairy production;

FIG. 4 is a schematic overview of a device according to an embodiment; and

FIG. 5 is a schematic overview of a device according to another embodiment.

### DETAILED DESCRIPTION

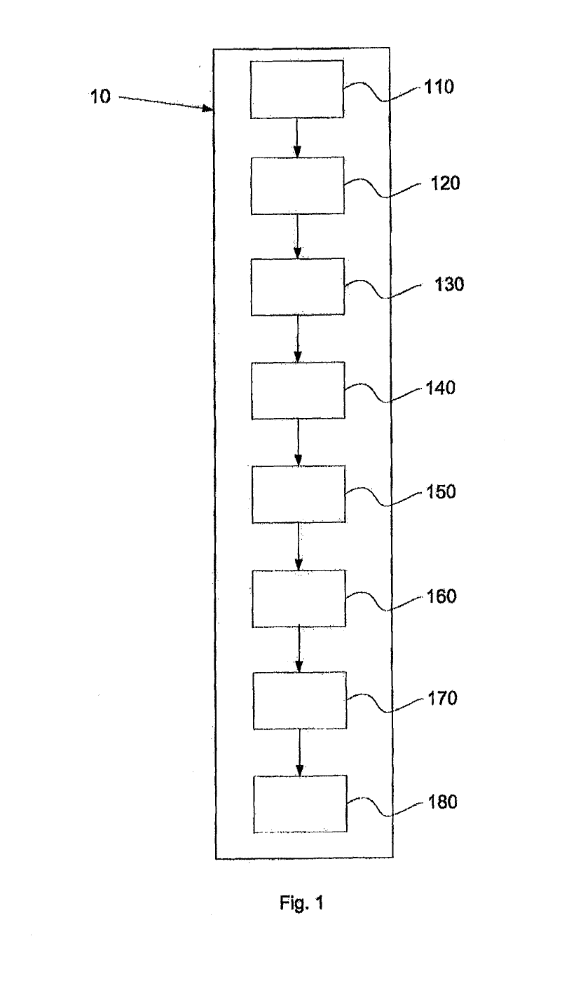

FIG. 1 is a flowchart schematically showing a method 10 for content tracking of a packaged content. The method first comprises a step 110 of obtaining information of the raw material. The method further comprises a step 120 of obtaining transport information. Next, the method comprises a step 130 of obtaining process information. The method also comprises a step 140 of obtaining packaging information. The method comprises a step 150 of storing said information of raw material, transport information, process information and packaging information in a database. Next, the method comprises a step 160 of cross referring said stored information. The method then comprises a step 170 of generating an output comprising said cross referenced information. Finally, the method comprises a step 180 of labeling a package of the packaged content with said output.

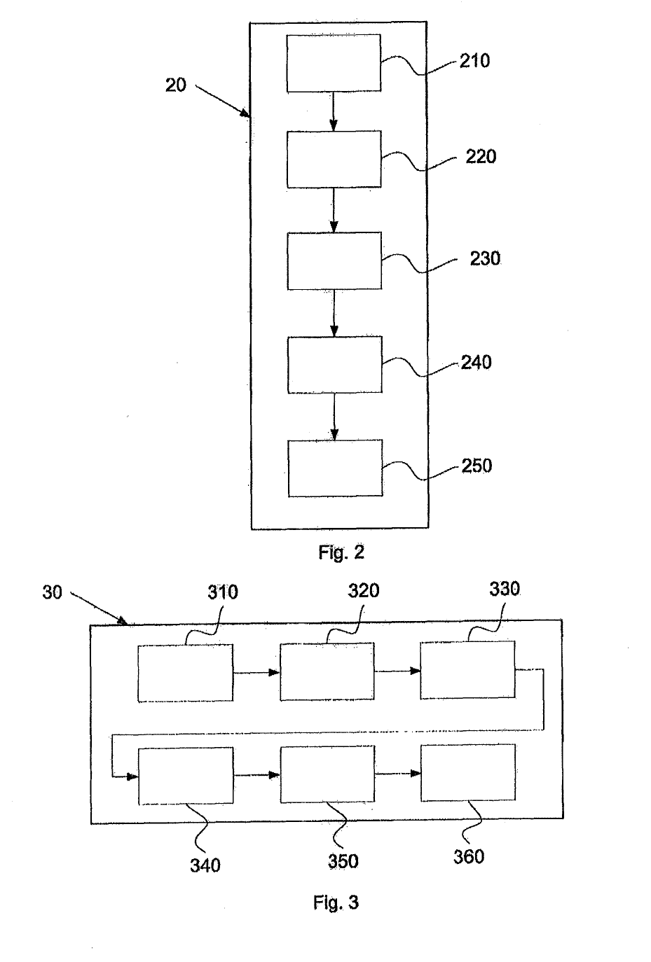

FIG. 2 is a flowchart schematically showing a method 20 for content tracking of a packaged content comprising, in addition to the steps shown above, a step 210 of obtaining secondary packaging information. The method further comprises a step 220 of storing said secondary packaging information in a database. Next, the method comprises a step 230 of cross referring said stored information. The method also comprises a step 240 of generating a second output comprising said cross referenced information. Finally, the method comprises a step 250 of labeling the secondary package with said second output.

Information of the Raw Material

The information of raw material may be any kind of information regarding production of the raw material, such as geographical origin, conditions of production, temporary storage conditions or quality control points during or at completion of production.

Transport Information

The transport information may be any kind of information regarding transport of the raw material from the production site to the processing site, such as information regarding mixing with other raw material, transport vehicle information, or transport conditions. The transport information enables the tying of the raw material information to the subsequent steps of processing, packaging and distribution. The transport information is of course also relevant for any transportation of any intermediate products, and not only tied to the transportation of raw material.

Process Information

The process information may be any kind of information regarding processing, such as information regarding ultra-high temperature (UHT) treatment, pasteurization conditions, receipt of processing, quality control points, processing conditions, or additives.

Packaging Information

The packaging information may be any kind of information regarding packaging, such as sealing parameters, aseptic parameters, cleaning parameters, production date/time, machine ID, splicing/spot test information, quality control points, or weight check.

Secondary Packaging Information

The secondary packaging information may be any kind of information regarding secondary packing, such as number of single packs in a multipack/box/pallet, unique ID, location in warehouse or labeling information.

The following description focuses on an embodiment of the present invention applicable to dairy production. However, it will be appreciated that the invention is not limited to this application but may be applied to many other production processes including for example food production such as juice production, meat production, vegetable production or production of ready-cooked food, or non-food production, such as chemical production or paint production.

The schematic process according to FIG. 3 illustrates an exemplary dairy production process 30. Milk is produced and collected at the site of production 310. Information regarding the cow, such as age and health is obtained. Information regarding the farm, such as fodder use and origin, temporary storage conditions, quality control points, geographical location is obtained. The information is stored in a database, well known to a person skilled in the art. The time stamp of each piece of information is also registered and stored together with the information in the database.

The milk is then collected and transported 320 to the processing site. Information regarding the transport vehicle and transport conditions is obtained. The information is stored in a database, well known to a person skilled in the art. The time stamp of each piece of information is also registered and stored together with the information in the database.

After transport, the milk arrives to the processing plant 330. Information on storing, i.e. how and where, provides traceability back to transport and thus to raw material information. For example, when milk is taken from a cistern for further processing, the information on storing, the information of the raw material, and the newly input information on processing can be linked together. Information regarding ultra-high temperature (UHT) treatment, pasteurization conditions, type of storage containers, receipt of processing, quality control points, processing conditions or additives is obtained. The information is stored in a database, well known to a person skilled in the art. The database may be any kind of database normally used for performing the involved tasks, e.g. an SQL database. However, the scope of the invention is not limited to this specific database.

The time stamp of each piece of information is also registered and stored together with the information in the database.

The processed milk is then packaged 340 with a filling machine. Information regarding sealing parameters, aseptic parameters, such as amount and concentration of H₂O₂ or its temperature, cleaning parameters and intervals, production date/time, machine ID, such as jaw ID indicating the identity of sealing members of the packaging machine, event ID, such as splicing of packaging material/spot test information, cleaning in place or short stops of the filling and packaging machine, quality control points, or weight check is obtained. The information is stored in a database, well known to a person skilled in the art. The time stamp of each piece of information is also registered and stored together with the information in the database.

After packaging, secondary packaging 350 is performed. Information regarding number of single packs in a multipack/box/pallet, unique ID of multipack/box/pallet, location in warehouse and/or labeling information is obtained. The information is stored in a database, well known to a person skilled in the art. The time stamp of each piece of information is also registered and stored together with the information in the database.

All the obtained information is cross referenced, based on the time stamp of each piece of information. This makes it possible to trace the milk along a timeline and accurately generating an output comprising said cross referenced information for each package of milk. Thus, the links of information provides for traceability all the way back to raw material source via all actions along the line. In order to improve the traceability, it is in one embodiment foreseen to use synchronized time-keeping between all the different units for collecting and tracking information. This synchronization can e.g. use an internet time server or a radio-signal from an accurate clock, such as an atomic clock.

The output can for example be a code printed on the package of the product. Especially on smaller packages, it is desirable that the printed code is not taking too much space of the outer surface of the package, since there also is a desire to use the outer surface for exposing trade mark, nutrition facts, decorations, etc. Therefore, the code is preferably rather concise, which for example can be provided by a number of stacked data fields as F+L+ProdDate+AlpaHour+MMSS+StationID, where F is fabrication plant, L is fabrication line, ProdDate is date of production, AlphaHour is hour of production, MMSS is minute and second of production, and StationID is the ID of the machine part used for sealing the package. It can for example be the ID of the sealing element, such as sealing jaw, injection mould sealing station, or capping device. The choice of data fields can of course comprise only a subset of the above demonstrated data fields, and/or comprise further data fields, as long as the packages or at least group of packages can be uniquely identified.

The output is a digit sequence unique for each package. Here, the digits can be represented by symbols of different alphabet sizes, such as numbers 0 to 9 or letters A to Z, to give suitable conciseness of the sequence, such that is may be printed as a compact code on the package. The output may also be presented by a bar code or DOT matrix.

The packaged milk is then delivered 360 via ordinary supply chains to end consumers.

After distribution, the database may be accessed using the unique package ID as a query and more detailed information may be retrieved, if wanted. The access, to the database may be moderated so that different amounts of information may be retrieved. A wholesaler may thus retrieve more information than an end customer. In an embodiment, a wholesaler web portal is provided, wherein the wholesaler may receive information regarding product safety. A customer hotline may also be provided, where end customers may receive information regarding for example geographical origin of the milk. This adds value to the customer experience. The customers also have the possibility to check on the properties of the products, such as transporting and processing information.

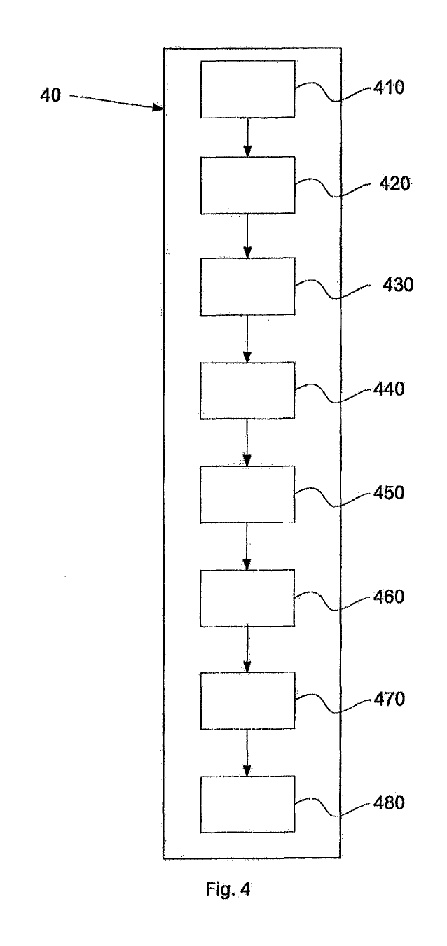

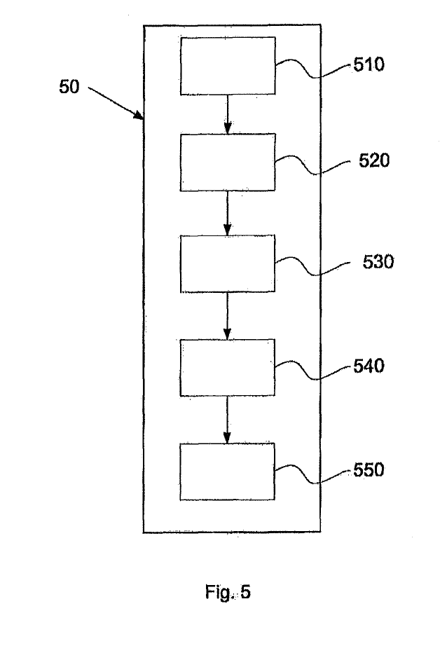

FIG. 4 is a schematic overview of a device 40 for content tracking of a packaged content according to an embodiment. The device 40 comprises a first unit 410 configured to obtain information of the raw material. The device 40 comprises a second unit 420 configured to obtain transport information. Further, the device 40 comprises a third unit 430 configured to obtain process information. The device 40 also comprises a fourth unit 440 configured to obtain packaging information. The device 40 comprises a fifth unit 450 configured to store said information of raw material, transport information, process information and packaging information in a database. The device 40 comprises a sixth unit 460 configured to cross refer said stored information. Furthermore, the device 40 comprises a seventh unit 470 configured to generate an output comprising said cross referenced information. The device 40 also comprises an eight unit 480 configured to label the package with said output.

The units 410, 420, 430, 440, 450, 460, 470, 480 are operatively connected to each other. The units 410, 420, 430, 440, 450, 460, 470, 480 may be embodied as separate physical entities, connected together via wired and/or wireless connection. However, the units 410, 420, 430, 440, 450, 460, 470, 480 may also be embodied in a singular physical entity. Any combination of the units 410, 420, 430, 440, 450, 460, 470, 480 may be embodied in different separate or unified physical entities. Said entities may further be combined in any setup, forming a connection between the physical entities via wired and/or wireless connection.

FIG. 5 is a schematic overview of a device 50 for content tracking of a packaged content according to an embodiment. The device 50 comprises, in addition to the units described above, a ninth unit 510 configured to obtain secondary packaging information. The device 50 also comprises a tenth unit 520 configured to store said secondary packaging information in a database. Furthermore, the device 50 comprises an eleventh unit 530 configured to cross refer said stored information. The device 50 comprises a twelfth unit 540 configured to generate a second output comprising said cross referenced information. Also, the device 50 comprises a thirteenth unit 550 configured to label the secondary package with said second output.

The units 510, 520, 530, 540, 550 are operatively connected to each other and to units 410, 420, 430, 440, 450, 460, 470, 480. The units 410, 420, 430, 440, 450, 460, 470, 480, 510, 520, 530, 540, 550 may be embodied as separate physical entities, connected together via wired and/or wireless connection. However, the units 410, 420, 430, 440, 450, 460, 470, 480, 510, 520, 530, 540, 550 may also be embodied in a singular physical entity. Any combination of the units 410, 420, 430, 440, 450, 460, 470, 480, 510, 520, 530, 540, 550 may be embodied in different separate or unified physical entities. Said entities may further be combined in any setup, forming a connection between the physical entities via wired and/or wireless connection.

The units 410, 420, 430, 440, 450, 460, 470, 480, 510, 520, 530, 540, 550 may be any units normally used for performing the involved tasks, e.g. a hardware, such as a processor with a memory. The processor may be any of variety of processors, such as Intel or AMD processors, CPUs, microprocessors, Programmable Intelligent Computer (PIC) microcontrollers, Digital Signal Processors (DSP), etc. However, the scope of the invention is not limited to these specific processors. The memory may be any memory capable of storing information, such as Random Access Memories (RAM) such as, Double Density RAM (DDR, DDR2), Single Density RAM (SDRAM), Static RAM (SRAM), Dynamic RAM (DRAM), Video RAM (VRAM), etc. The memory may also be a FLASH memory such as a USB, Compact Flash, SmartMedia, MMC memory, MemoryStick, SD Card, MiniSD, MicroSD, xD Card, TransFlash, and MicroDrive memory etc. However, the scope of the invention is not limited to these specific memories.

The database may be any kind of database normally used for performing the involved tasks, e.g. an SQL database. However, the scope of the invention is not limited to this specific database.

In an embodiment the device 40, 50 comprise units for performing the method according to some embodiments.

The method according to some embodiments or the device according to some embodiments may be used for content tracking of a packaged.

The Invention in General

The invention may generally be described as a system and a method for tracking a batch of liquid product from being input in a process to being output from the process in the form of a package with information about the liquid content provided thereon.

The process may be a milk processing and packaging process embracing the steps of collecting the raw milk at a farm, transporting the raw milk from the farm to a dairy, processing the raw milk in the dairy and finally packaging the milk. The steps may in turn comprise a number of sub-steps, e.g. the processing step may include sub-steps of storing the raw milk, separating the raw milk, pasteurizing or UHT treating the milk and homogenizing the milk.

Unlike many other tracking systems the product cannot due to legislations and health aspects be marked. However, the same wish to know the origin of the product as well as how it has been treated also exists for liquid products, such as milk. By knowing the origin of the product and how the product has been treated a producer, such as a dairy, can guarantee that the product is safe to consume. Further, by knowing this the producer can know which product to discard if e.g. milk received from a certain farm turns out to contain unwanted substances, such as traces of medicaments, which in turn implies improved efficiency.

In order to keep track of the liquid product it is handled batch by batch. During the process several batches may be combined into a larger batch. This may for instance, occur when milk from different batches are stored in the same storage container.

Further, each batch is tracked by collecting information from all operations performed to the batch. This information can be an ID of the operation, a time stamp associate to when the operation has been performed, an ID of the current process step and an ID of the future process step. Since the combination of the time stamp, the ID of the current process step and the ID of the future process step is unique the ID of the operation can be omitted. Alternatively, instead of saving the ID of the future process step, an ID of the prior process may be saved. Further, still an option, if an order of the process steps is known, is to save only the time stamp and the ID of the current process step. By knowing the order of the process steps and the time stamps associated to the different process steps a batch can be followed through the process.

For example, a batch of milk to be sent to a filling machine, i.e. a machine packaging the milk in packages, can be tracked back to a UHT treatment device, there from to homogenizing device, and so on, back to a receiver tank receiving milk from a farm. Thus, the farm producing the milk can be printed on the packages.

As can be readily understood by a skilled person, the tracking method and system described can also be used for tracking products which can be marked, but for any reason prefer a tracking system not requiring that the products are marked.

Method Performed in Machine Units

The system comprises a number of machine units performing processing steps. A method performed in the number of machine units may be described as a method for handling tracking information related a product in a machine unit arranged to process said product, said method comprising storing a time stamp when said product is processed, and sending an identification associated to said machine unit and said time stamp to a tracking device.

The step of sending said identification and said time stamp to a tracking device may be performed when it is requested by the tracking device or continuously, that is, as soon as new information is stored.

Further, as described above, an identification of a prior machine unit may be stored or an identification of a future machine unit may be stored.

Further, if more than one process step is performed per machine unit, the machine unit may for this purpose be divided in sub-machine units and identification and time stamp may be stored for each of these.

Further, an identification of the operation may be stored and sent as well.

The wording processing should in this context be interpreted broadly as anything happening from the product is received to the product is forward to the next machine unit in a processing line.

Method Performed in the Tracking Device

The function of the tracking device may be described as

a method for tracking a product, said method comprising

receiving a time stamp and an identification from each of a number of machine units, and

determining a path of the product through said number of machine units based on said time stamp and said identification from each of said number of machine units.

Further, apart from said time stamp and said identification, an identification of a prior machine unit may be received or an identification of a future machine unit may be received for each of said machine units. Moreover, an identification of the operation may be received from each of said number of machine units.

The path may comprise a chain of operations described by a number of identifications of operation received from said number of machine units. An advantage of this is that if a certain machine unit has not performed as expected during a certain time interval, operations associated to this certain time interval may be determined, and, in turn, by using said chain of operations, batches affected by this may be determined.

Further, additional information associated to a combination of said time stamp and said identification, or said identification of operation, may be added to the chain to the path of the product. For instance, the origin of the milk received in a first processing step may be manually entered and associated to said combination of said time stamp and said identification, or said identification of operation.

The tracking device may be a device, such as a computer, placed on site together with the machine units of the processing line, but it may also be a remote computer not placed at site. Further, the tracking may be performed by many tracking devices in parallel. For instance, one tracking device may be placed at site, one tracking device may be placed elsewhere as a back-up and one tracking device may be placed at the system supplier in order to make sure that quick and reliable support can be given efficiently.

1. A method for content tracking of a packaged content comprising the steps of
obtaining information of the raw material;
obtaining transport information;
obtaining process information;
obtaining packaging information;
storing said information of raw material, transport information, process information and packaging information in a database;
cross referring said stored information;
generating an output comprising said cross referenced information; and
labelling the package with said output.

2. The method according to claim 1, further comprising the steps of:
obtaining secondary packaging information
storing said secondary packaging information in a database;
cross referring said stored information;
generating a second output comprising said cross referenced information; and
labelling the secondary package with said second output.

3. The method according to claim 1, wherein at least one of said steps is automatic.

4. The method according to claim 1, wherein at least one of said steps is manual.

5. The method according to claim 1, wherein said information is stored together with a time stamp.

6. The method according to claim 5, wherein the cross referring is performed by synchronizing time stamps of the stored information.

7. The method according to claim 1, wherein said information is stored in a database with a certificate to assure that the data remains intact.

8. A device for content tracking of a packaged content, said device comprising
a first unit configured to obtain information of the raw material;
a second unit configured to obtain transport information;
a third unit configured to obtain process information;
a fourth unit configured to obtain packaging information;
a fifth unit configured to store said information of raw material, transport information, process information and packaging information in a database;
a sixth unit configured to cross refer said stored information;
a seventh unit configured to generate an output comprising said cross referenced information;
an eighth unit configured to label the package with said output; and
said units being operatively connected to each other.

9. The device according to claim 8, further comprising
a ninth unit configured to obtain secondary packaging information
a tenth unit configured to store said secondary packaging information in a database;
an eleventh unit configured to cross refer said stored information;
a twelfth unit configured to generate a second output comprising said cross referenced information; and
a thirteenth unit configured to label the secondary package with said second output.

10. Use of the method according to claim 1 for content tracking of a packaged content.

11. A non-transitory computer readable medium containing a computer program including program instructions which when executed by a processor cause the processor to perform a method comprising:
obtaining information of the raw material;
obtaining transport information;
obtaining process information;
obtaining packaging information;
storing said information of raw material, transport information, process information and packaging information in a database;
cross referring said stored information;
generating an output comprising said cross referenced information; and
labelling the package with said output.

12. The non-transitory computer readable medium containing the computer program according to claim 11, further comprising instructions which when executed by the processor cause the processor to, based on a labelling information from a package, retrieve the stored information.

13. The non-transitory computer readable medium containing the computer program according to claim 11, further comprising instructions which when executed by the processor cause the processor to, based on any of the stored information of raw material, transport information, process information and packaging information in the database, determine any labels of packages associated therewith.

14. Use of the device according to claim 8, for content tracking of a packaged content.

15. The method according to claim 2, wherein at least one of said steps is automatic.

16. The method according to claim 2, wherein at least one of said steps is manual.

17. The method according to claim 2, wherein said information is stored together with a time stamp.

18. The method according to claim 2, wherein said information is stored in a database with a certificate to assure that the data remains intact.
